(19) United States
(12) Patent Application Publication
(10) Pub. No.: US 2015/0279645 A1
(43) Pub. Date: Oct. 1, 2015

(54) MASS SPECTROSCOPE AND MASS SPECTROMETRY

(71) Applicant: KABUSHIKI KAISHA TOSHIBA, Minato-ku (JP)

(72) Inventor: Haruko AKUTSU, Yokosuka (JP)

(73) Assignee: KABUSHIKI KAISHA TOSHIBA, Minato-ku (JP)

(21) Appl. No.: 14/542,908

(22) Filed: Nov. 17, 2014

Related U.S. Application Data
(60) Provisional application No. 61/970,947, filed on Mar. 27, 2014.

(51) Int. Cl. H01J 49/04; H01J 49/26

(52) U.S. Cl. CPC H01J 49/0418; H01J 49/26

(57) ABSTRACT

According to an embodiment, a mass spectroscope has a chamber, a charged particle beam source, a laser beam source, a mass spectrograph, and an optical system. The chamber accommodates a sample. The charged particle beam source generates a charged particle beam and irradiates the sample with the charged particle beam, thereby discharging a neutral particle from the sample. The laser beam source irradiates the neutral particle with a laser beam. The mass spectrograph detects the neutral particle ionized by irradiation of the laser beam and analyzes a mass of the sample. The optical system controls a light path of the laser beam in such a manner that the laser beam enters a region into which the neutral particle is discharged.

### CROSS REFERENCE TO RELATED APPLICATIONS

This application is based upon and claims the benefit of U.S. provisional Application No. 61/970,947, filed on Mar. 27, 2014, the entire contents of which are incorporated herein by reference.

### FIELD

Embodiments described herein relate generally to a mass spectroscope and a mass spectrometry.

### BACKGROUND

As a measuring apparatus that specifies an element in a sample, a mass spectroscope is used. In particular, as an apparatus that realizes a mass spectrometry with high sensitivity, there is known a Laser Ionization MAss nanoScope (LIMAS) that ionizes neutral particles, which are sputtered by irradiating a sample with an ion beam, with the use of a laser beam and performs the mass spectrometry of the sample by measuring a mass spectrum of generated ions.

However, at the time of ionizing the neutral particles, a gas or suspended matters in a chamber are also irradiated with the laser beam, and these materials are ionized at the same time. As a result, a background of the spectrum is raised, which results in a problem of a hindrance to higher sensitivity.

### BRIEF DESCRIPTION OF THE DRAWINGS

In the accompanying drawings,

FIG. 1 is an example of a block diagram showing an outline configuration of a mass spectroscope according to Embodiment 1;

FIG. 2 is an example of a block diagram showing a modification of the mass spectroscope depicted in FIG. 1;

FIG. 3 is an example of a block diagram showing an outline configuration of a mass spectroscope according to Embodiment 2;

FIG. 4 is an example of a block diagram showing an outline configuration of a mass spectroscope according to Embodiment 3; and

FIG. 5 is an example of a block diagram showing an outline configuration of a mass spectroscope according to Embodiment 4.

### DETAILED DESCRIPTION

According to an embodiment, a mass spectroscope has a chamber, a charged particle beam source, a laser beam source, a mass spectrograph, and an optical system. The chamber accommodates a sample. The charged particle beam source generates a charged particle beam and irradiates a sample with the charged particle beam, thereby discharging a neutral particle from the sample. The laser beam source irradiates the neutral particle with a laser beam. The mass spectrograph detects the neutral particles ionized by irradiation of the laser beam and analyzes a mass of the sample. The optical system controls a light path of the laser beam so that the laser beam can enters a region where the neutral particles are discharged.

An embodiment will now be described hereinafter with reference to the drawings. In the drawings, like reference numerals denote like parts to appropriately omit an overlapping description thereof.

Each of the accompanying drawings is used for promoting an explanation and an understanding of the present invention, and it is to be noted that shapes, dimensions, ratios, and others in the respective drawings may be different from counterparts in an actual apparatus. Persons skilled in the art can appropriately subject these differences to design change while considering the following description and a well-known technology.

### (1) Embodiment 1

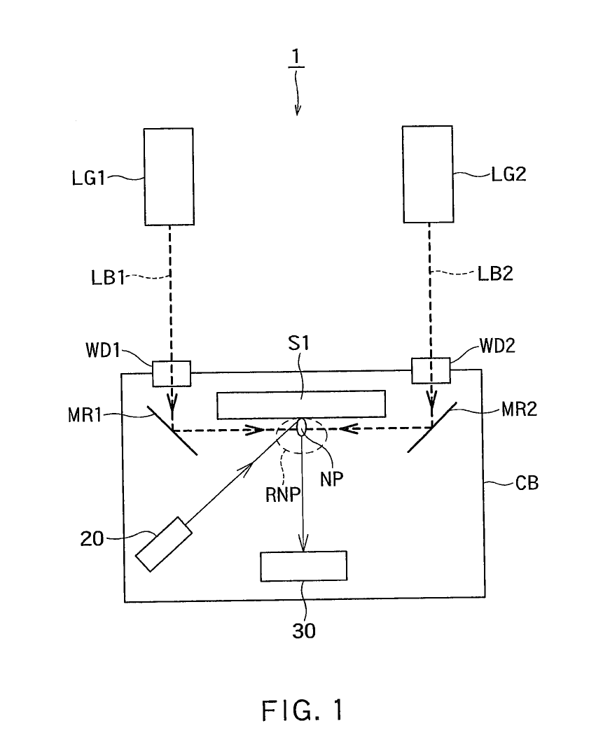

FIG. 1 is an example of a block diagram showing an outline configuration of a mass spectroscope according to Embodiment 1. As shown in FIG. 1, a mass spectroscope 1 according to this embodiment includes an ion beam gun 20, laser beam sources LG1 and LG2, and a mass spectrograph 30. The ion beam gun 20, the mass spectrograph 30, and a sample S1 as an analysis target are set in a chamber CB. The chamber CB is subjected to vacuum drawing by a non-illustrated vacuum pump prior to a mass spectrometry.

The sample S1 is held on a non-illustrated sample holder and disposed near a wall surface of the chamber CB, i.e., near a wall surface of a top portion in an example shown in FIG. 1.

The ion beam gun 20 generates an ion beam and irradiates the sample S1 with it. A surface of the sample S1 is sputtered by irradiation of the ion beam, whereby a secondary particle NP jumps out of the sample S1. In this embodiment, the ion beam corresponds to, e.g., a charged particle beam source, and the ion beam gun 20 corresponds to, e.g., a charged particle beam source.

The laser beam sources LG1 and LG2 are installed outside the chamber CB, generate laser beams LB1 and LB2 as pulse beams, respectively, and emit them toward windows WD1 and WD2 on a wall surface of the chamber CB from the outside of the chamber CB. The windows WD1 and WD2 are provided to sandwich the sample S1 in a region of the wall surface of the chamber CB close to the sample S1. Mirrors MR1 and MR2 are disposed on light paths of the laser beams LB1 and LB2 in the chamber CB. As a result, the laser beams LB1 and LB2 emitted from the laser beams sources LG1 and LG2 are transmitted through the windows WD1 and WD2, reflected on the mirrors MR1 and MR2, and enter a region RNP into which the secondary particles NP has jumped out.

The secondary particle NP is ionized by irradiation of the laser beams LB1 and LB2.

The mass spectrograph 30 measures a mass spectrum of the ionized secondary particle NP and performs a mass spectrometry based on a measurement result.

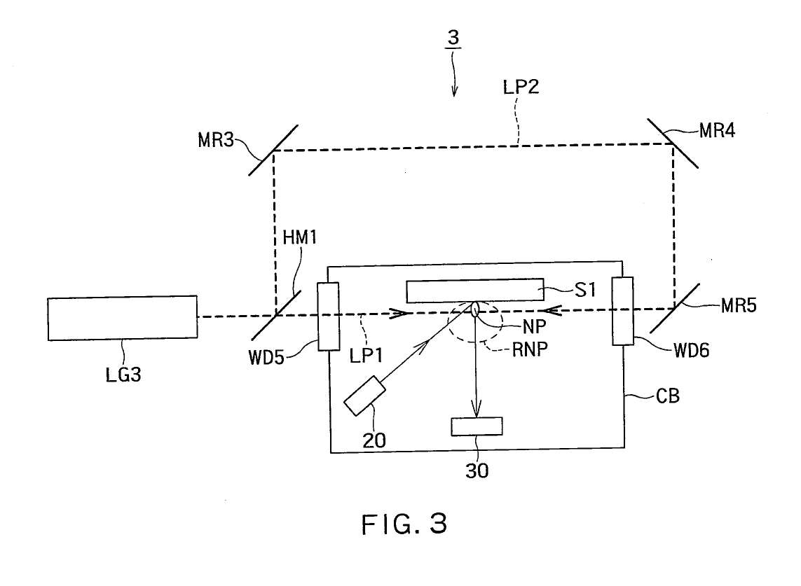

According to the mass spectroscope 1 of this embodiment, the secondary particle NP is irradiated with the laser beams LB1 and LB2 with short light path lengths through the windows WD1 and WD2 provided near the sample S1. As a result, for example, as compared with a case where the laser beams LB1 and LB2 are introduced through windows provided at positions far from the sample S1 like windows WD5 and WD6 shown in FIG. 3, an amount of a gas or suspended matters irradiated with the laser beams in the chambers can be reduced. As a result, a rise of the background of the spectrum can be suppressed, and analysis sensitivity can be improved.

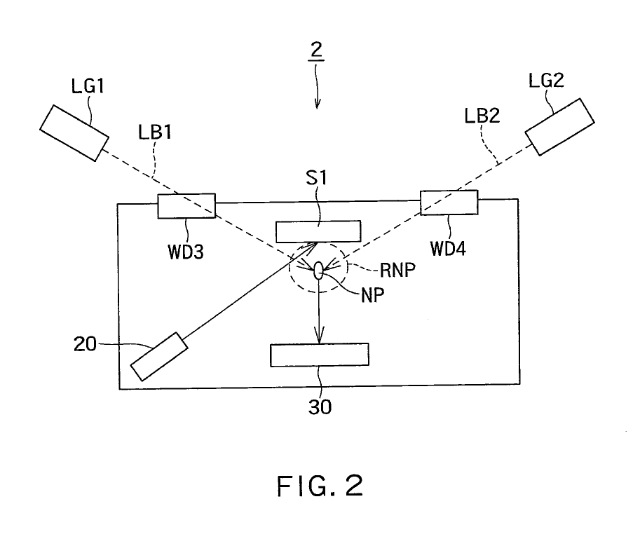

If the short light path lengths can be realized, for example, like a mass spectroscope 2 shown in FIG. 2 as a modification, a region RNP into which a secondary particle NP jumps out can be directly irradiated with laser beams LB1 and LB2 through windows WD3 and WD4 without installing mirrors in a chamber CB. In this case, it is possible to avoid a reduction in irradiation intensity caused due to contamination of the mirrors.

In this embodiment, an example is given where the sample S1 is set near the wall surface of the top portion of the chamber CB and the ion beam gun 20 and the mass spectrograph 30 are arranged on a bottom portion of the chamber CB. However, arrangement of these elements is not restricted to the examples shown in FIG. 1 and FIG. 2. For example, the sample S1 may be arranged near the wall surface of the bottom portion of chamber CB and the ion beam gun 20 and the mass spectrograph 30 may be installed at the top portion of the chamber CB. This point can be likewise applied to the following Embodiments 2 to 4.

### (2) Embodiment 2

FIG. 3 is an example of a block diagram showing an outline configuration of a mass spectroscope according to Embodiment 2. A mass spectroscope shown in FIG. 3 includes an ion beam gun 20 and a mass spectrograph 30 that are the same as the mass spectroscopes 1 and 2 described above. The mass spectroscope 3 according to this embodiment further includes a single laser beam source LG3 that emits a pulse beam and an optical system in which optical elements are arranged in such a manner that a laser can interfere in a region RNP into which a secondary particle NP jumps out.

The windows WD5 and WD6 through which a laser beam from the laser beam source LG3 is transmitted are provided on opposed side surfaces of a chamber CB so that they face each other to interpose the region RNP therebetween in this embodiment.

The optical system of the mass spectroscope 3 according to this embodiment includes a half mirror HM1 and three mirrors MR3 to MR5. The half mirror HM1 and the mirror MR5 are arranged outside the side surfaces of the chamber CB to correspond to the windows WD5 and WD6. The mirrors MR3 and MR4 are arranged immediately above the half mirror HM1 and the mirror MR5 to be placed above the chamber CB.

Based on such a configuration of the optical system, a light path along which the laser beam from the laser beam source LG3 travels branches into two light paths LP1 and LP2 by the half mirror HM1.

The light path LP1 is a light path that directly extends from the half mirror HM1 to the region RNP. Of the laser beam emitted from the laser beam source LG3, a laser beam transmitted through the half mirror HM1 travels along the light path LP1 and enters the region RNP via the window WD5.

The light path LP2 is a light path that makes a detour to the upper side of the chamber CB and reaches the region RNP via the window WD6. Of the laser beam emitted from the laser beam source LG3, a laser beam reflected by the half mirror HM1 is reflected by the mirrors MR3 and MR4, again reflected by the mirror MR5 arranged on an extended line of the light path LP1, and enters the region RNP via the window WD6.

In this embodiment, detailed paths and light path lengths of these two light paths LP1 and LP2 are adjusted so that the laser beams that have traveled along the respective light paths can interfere in the region RNP. As a result, since intensity of each laser beam is increased in the region RNP where many secondary particles NP that have jumped out of the sample S1 are distributed, a background of a spectrum is relatively lowered, and analysis sensitivity can be improved.

### (3) Embodiment 3

In addition to such interference of a plurality of laser beams as that described in Embodiment 2, intensity of a laser beam can be further increased when the laser beam is transmitted through a convex lens. An example of an apparatus that realizes such a configuration will now be described as a mass spectroscope according to Embodiment 3.

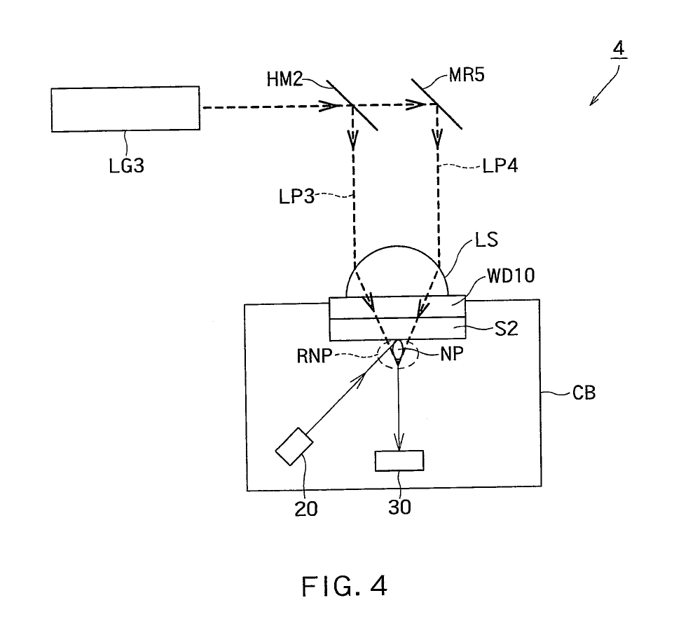

Specifically, as shown in FIG. 4, a mass spectroscope 4 according to this embodiment includes an ion beam gun 20, a mass spectrograph 30, a single laser beam source LG3, and an optical system arranged so that laser beams can interfere in a region RNP in addition to a convex lens LS.

A window WD10 through which a laser beam from the laser beam source LG3 is allowed to enter a chamber CB is provided on a wall surface of a top portion of the chamber CB.

A sample S2 is held on a non-illustrated sample holder and set immediately below a window WD10. The sample S2 used in this embodiment is made of a material having a transmittance that allows a laser beam to pass therethrough.

In this embodiment, the optical system includes a half mirror HM2, a mirror MR5, and a convex lens LS. The convex lens LS is installed below the half mirror HM2 and the mirror MR5 and immediately above the window WD.

A light path along which a laser beam from the laser beam source LG3 travels branches into two light paths LP3 and LP4 by the half mirror HM2.

A laser beam emitted from the laser beam source LG3 and then reflected by the half mirror HM2 enters the convex lens LS via the light path LP3, is refracted, transmitted through the window WD10 and the sample S2, and strikes upon a secondary particle NP that has jumped out of the sample S2 in the region RNP.

Additionally, a laser beam emitted from the laser beam source LG3 and then transmitted through the half mirror HM2 travels along the light path LP4, is reflected by the mirror MR5. The laser then enters the convex lens LS, refracted, transmitted through the window WD10 and the sample S2, and strikes upon the secondary particle NP that has jumped out of the sample S2 in the region RNP.

In this embodiment, likewise, detailed paths and light path lengths of the two light paths LP3 and LP4 are adjusted so that the laser beams that have travelled along the respective light paths can interfere in the region RNP. Further, a refractive index of the convex lens LS is adjusted so that the laser beam transmitted therethrough can be transmitted through the window WD10 and the sample S2 and condensed in the region RNP.

As described above, according to the mass spectroscope 4 of this embodiment, a lens function of the convex lens LS as well as interference of the laser beams can enhance intensity of each laser beam in the region RNP where many secondary particles NP that have jumped out of the sample S2 are distributed. As a result, since a background of a spectrum is further lowered, analysis sensitivity can be further improved.

### (4) Embodiment 4

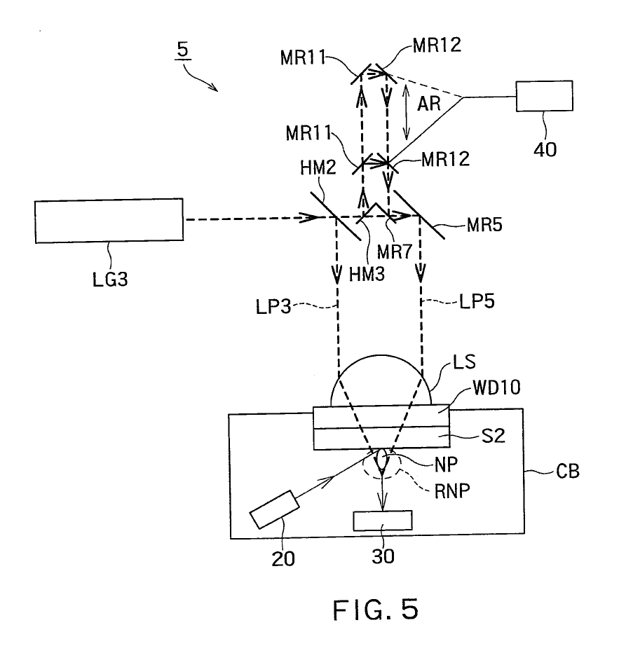

FIG. 5 is an example of a block diagram showing an outline configuration of a mass spectroscope according to Embodiment 4. As obvious from a comparison with FIG. 4, a mass spectroscope 5 according to this embodiment includes an optical system in which a half mirror HM3, three mirrors MR7, MR11, and MR12, and a manipulator 40 are further provided in addition to the configuration shown in FIG. 4.

The half mirror HM3 and the mirror MR7 are installed on a path along which a laser beam transmitted through a half mirror HM2 strikes upon a mirror MR5. The mirrors MR11 and MR12 are installed away from the half mirror HM3 and the mirror MR7 in a direction vertical to a sample S2, i.e., a direction of an arrow AR in FIG. 5. In an example shown in FIG. 5, the mirrors MR11 and MR12 are installed above the half mirror HM3 and the mirror MR7.

A laser beam emitted from the laser beam source LG3 and then transmitted through the half mirror HM2 travels along the light path LP5, and strikes upon the half mirror HM3. The laser beam reflected by the half mirror HM3 is reflected by the four mirrors MR11, MR12, MR7, and MR5, then enters a convex lens LS, refracted, transmitted through a window WD10 and the sample 2, and strikes upon a secondary particle NP that has jumped out of the sample S2 in a region RNP.

The manipulator 40 is coupled with the mirrors MR11 and MR12 and moves these mirrors MR11 and MR12 a desired distance in a direction vertical to the sample S2, i.e., a direction of an arrow AR in FIG. 5. As a result, of two light paths LP3 and LP5 branched by the half mirror HM2, the light path LP5 along which the laser beam transmitted through the half mirror HM2 travels can have a light path length adjusted, whereby a spatial range where two laser beams can interfere can be controlled.

The manipulator 40 can be constituted by using, e.g., an MEMS (Micro Electro Mechanical Systems) including a piezoelectric element. In this embodiment, the manipulator 40 corresponds to, e.g., a light path length adjustment mechanism.

Structures other than the optical system in the mass spectroscope 5 according to this embodiment are substantially the same as those in the mass spectroscope 4 shown in FIG. 4.

As described above, according to the mass spectroscope 5 of this embodiment, the mass spectroscope 5 is provided with the manipulator 40 that is coupled with the mirrors MR11 and MR12 and adjusts the light path length of the light path LP5 along which the laser beam transmitted through the half mirror HM2 travels. Thus, the spatial range where a plurality of laser beams can interfere can be controlled. As a result, intensity of each laser beam can be enhanced in the desired spatial range in the region RNP where many secondary particles NP jumped out of the sample S2 are distributed. Consequently, mass analysis with a higher accuracy can be conducted.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A mass spectroscope comprising:
a chamber configured to accommodate a sample;
a charged particle beam source configured to generate a charged particle beam and irradiate the sample with the charged particle beam, thereby discharging a neutral particle from the sample;
a laser beam source configured to irradiate the neutral particle with a laser beam;
a mass spectrograph configured to detect the neutral particle ionized by irradiation of the laser beam and analyze a mass of the sample; and
an optical system configured to control a light path of the laser beam in such a manner that the laser beam enters a region into which the neutral particle is discharged.

2. The mass spectroscope of claim 1,
wherein the optical system comprises an optical element that comprises a mirror and controls the light path by reflecting at least part of the laser beam by the mirror.

3. The mass spectroscope of claim 2 further comprising:
a first window on a wall surface of the chamber, which is arranged on a first light path connecting the laser beam source and the neutral particle;
a second window on the wall surface of the chamber, which is arranged so as to face each other across the neutral particle,
wherein the optical element comprises a half mirror between the laser beam source and the first window, and
the mirrors are arranged in such a manner that light reflecting the half mirror incident on the second window through a second light path.

4. The mass spectroscope of claim 1 further comprising:
a window on a wall surface on a side on which a sample holder holding the sample is arranged;
a first half mirror by which a light path along which the laser beam from the laser beam source travels branches into first and second light paths;
a first mirror on the second light path, which reflects the laser beam having passed through the half mirror to allow the reflected laser beam to enter the chamber; and
a convex lens on the window, which is arranged outside the chamber,
wherein a refractive index of the convex lens is adjusted in such a manner that the laser beam having transmitted therethrough passes through the window and the sample to condense in the region of the neutral particle.

5. The mass spectroscope of claim 4 further comprising:
second mirrors and second half mirrors arranged so as to create bypass light paths between the first half mirror and the first mirror, each of the light paths branching off from the second light path and returns back to the second light path; and
a manipulator configured to move the second mirrors and the second half mirrors arranged on the bypass light paths, thereby adjusting the length of the second light path.

6. The mass spectroscope of claim 1,
wherein the laser beam source generates a laser beam as a pulse beam.

7. A mass spectrometry comprising:
generating a charged particle beam and irradiating a sample with the charged particle beam;
irradiating a neutral particle, which is discharged from the sample by irradiation of the charged particle beam, with a laser beam;
detecting the neutral particle ionized by irradiation of the laser beam and analyzing a mass of the sample; and
adjusting the light path in such a manner that the laser beam that has traveled along the plurality of light paths enters a region into which the neutral particle is discharged.

8. The mass spectrometry of claim 7,
wherein the laser beam is generated as a pulse beam.

9. A mass spectroscope comprising:
a chamber configured to accommodate a sample;
a charged particle beam source configured to generate a charged particle beam and irradiate the sample with the charged particle beam, thereby discharging a neutral particle from the sample;
a laser beam source configured to irradiate the neutral particle with a laser beam; and
a mass spectrograph configured to detect the neutral particle ionized by irradiation of the laser beam and analyze a mass of the sample,
wherein the chamber comprises a plurality of windows, through which the laser is transmitted, on a wall surface of the chamber on a side where the sample is held.

10. The mass spectroscope of claim 9, further comprising a mirror configured to reflect the laser beam which has been transmitted through the window and entered the chamber,
wherein the mirror is provided in such a manner that the reflected laser beam strikes upon the neutral particle.

11. The mass spectroscope of claim 10 comprises a plurality of laser beam sources and pairs of windows and mirrors, each pair of the windows and mirrors being arranged in association with each of the laser beam sources.

12. The mass spectroscope of claim 10 comprises a plurality of laser beam sources and a plurality of windows,
wherein each of the windows is arranged on the light path from the corresponding laser beam source and the sample.

13. The mass spectroscope of claim 9,
wherein the laser beam source generates a laser beam as a pulse beam.
